(19) United States
(12) Patent Application Publication
(10) Pub. No.: US 2026/0012551 A1
(43) Pub. Date: Jan. 8, 2026

(54) INFORMATION PROCESSING APPARATUS, INFORMATION PROCESSING METHOD, STORAGE MEDIUM, AND MULTI-FUNCTION PRINTER

(71) Applicant: CANON KABUSHIKI KAISHA, Tokyo (JP)

(72) Inventors: KEN ACHIWA, Kanagawa (JP); NAOKI ITO, Tokyo (JP)

(21) Appl. No.: 19/249,810

(22) Filed: Jun. 25, 2025

(30) Foreign Application Priority Data
Jul. 2, 2024 (JP) 2024-106838

(51) Int. Cl. H04N 1/387; H04N 1/00

(52) U.S. Cl. CPC H04N 1/387; H04N 1/00244; H04N 2201/0094

(57) ABSTRACT

An information processing method includes receiving an instruction that causes a generative artificial intelligence (AI) to generate document data, the document data being generated by rearranging the information included in an original document image according to layout of a sample file, and the instruction being generated based on a user operation, acquiring the original document image, acquiring the sample file, generating an instruction statement corresponding to the received instruction, and transmitting the original document image, the sample file, and the instruction statement to a server of the generative AI.

### BACKGROUND

### Field

The present disclosure relates to a technique for converting a document image using a generative artificial intelligence (AI).

### Description of the Related Art

In recent years, generative artificial intelligence (AI) capable of automatically generating creative content such as an image, text, and audio has rapidly gained popularity. Accordingly, a variety of services utilizing generative AI are now being offered.

For example, Japanese Patent No. 7398723 discusses an image generation apparatus that generates an instruction statement (prompt) including text (prompt element) corresponding to a tag selected by a user, inputs the generated instruction statement (prompt) to a generative AI, and outputs an image generated using the generative AI.

However, the image generation apparatus discussed in Japanese Patent No. 7398723 is not capable of obtaining a conversion result from the generative AI in the form of data (e.g., application file in Office® format) laid out or designed to match a user intention based on an original document, such as a paper document. Specifically, since a scanned document image of the original document must be submitted to the generative AI and the user is required to input a text instruction statement (prompt) describing the layout and design of the data into which the document image is to be converted, there has been an issue with the burden of inputting such an instruction.

### SUMMARY

The present disclosure is directed to performing a conversion based on a user intention by inputting a pair of an image and text to a generative AI to which multimodal data including an image and text can be input, based on a user instruction.

According to an aspect of the present disclosure, an information processing method includes receiving an instruction that causes a generative artificial intelligence (AI) to generate document data, the document data being generated by rearranging the information included in an original document image according to layout of a sample file, and the instruction being generated based on a user operation, acquiring the original document image, acquiring the sample file, generating an instruction statement corresponding to the received instruction, and transmitting the original document image, the sample file, and the instruction statement to a server of the generative AI.

Further features of the present disclosure will become apparent from the following description of exemplary embodiments with reference to the attached drawings.

### BRIEF DESCRIPTION OF THE DRAWINGS

FIG. 1 is a diagram illustrating an example of a configuration of an information processing system.

FIGS. 2A, 2B, and 2C are diagrams illustrating examples of hardware configurations of apparatuses constituting the information processing system.

FIGS. 3A and 3B are diagrams illustrating sequences of the information processing system.

FIG. 4 is a flowchart for setting a scan extension function in the information processing system.

FIG. 5 is a flowchart for converting a document image in the information processing system.

FIGS. 6A and 6B are diagrams illustrating setting screens for setting the scan extension function.

FIGS. 7A, 7B, and 7C are diagrams illustrating a data flow for document image conversion and example screens.

FIGS. 8A, 8B, 8C, 8D, 8E, 8F, 8G, and 8H are diagrams illustrating application file conversion setting screens.

FIGS. 9A and 9B are diagrams illustrating a setting screen for configuring an advanced setting of the scan extension function.

FIGS. 10A and 10B are diagrams illustrating a data flow for document image conversion and example screens according to a second exemplary embodiment.

### DESCRIPTION OF THE EMBODIMENTS

Various exemplary embodiments of the present disclosure will be described below with reference to the drawings. Note that the components described in the following exemplary embodiments are provided as examples and are not intended to limit the scope of the technique discussed herein. For example, each component constituting the present disclosure can be replaced with any configuration that can exhibit a similar function. Further, any configuration may also be added.

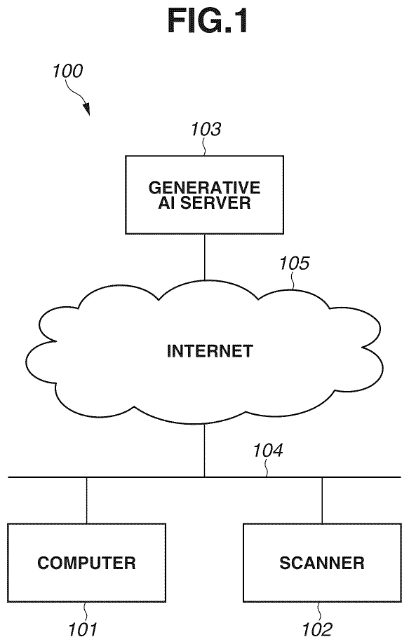

FIG. 1 is a block diagram illustrating an example of a network configuration of an information processing system 100 according to a first exemplary embodiment of the present disclosure.

As illustrated in FIG. 1, the information processing system 100 includes a computer 101, a scanner (reading apparatus) 102, and a generative artificial intelligence (AI) server 103. The computer 101 is a terminal apparatus. The scanner 102 is configured to read an original document, such as a paper document. For example, the computer 101 and the scanner 102 are installed in an office and are communicatively connected to each other via an internal network 104. The internal network 104 is connected to an external network, such as the Internet 105, via a router (not illustrated).

The generative AI server 103 is communicatively connected to the computer 101 and the scanner 102 via the Internet 105 and the internal network 104. The generative AI server 103 is a server managed by a generative AI service provider. The generative AI server 103 may be configured for use in combination with a plugin that implements an additional function developed by a provider of a service that utilizes generative AI. Further, the internal network 104 may be established via a wired or wireless connection.

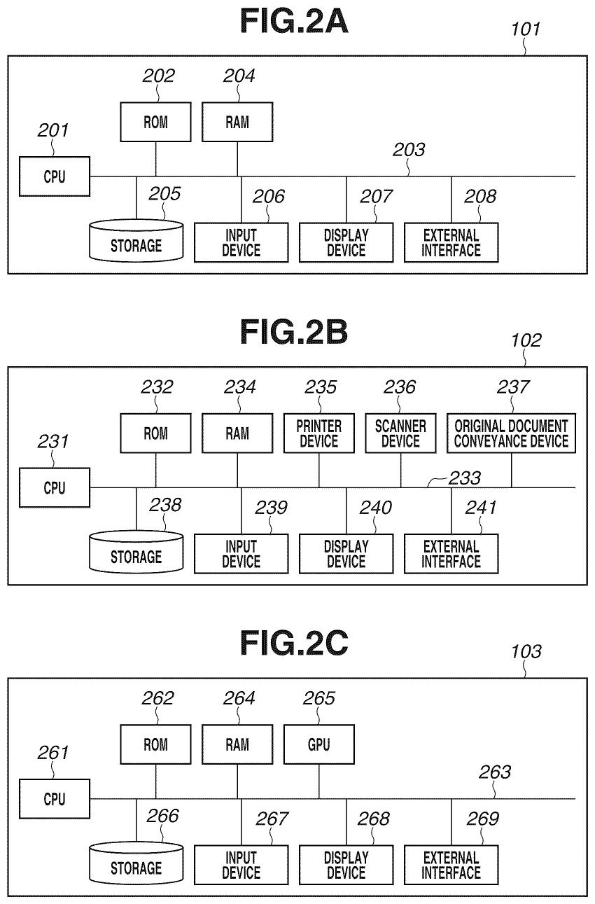

FIGS. 2A, 2B, and 2C are diagrams illustrating examples of hardware configurations of the computer 101, the scanner 102, and the generative AI server 103 constituting the information processing system 100.

FIG. 2A is a diagram illustrating a hardware configuration of the computer 101. As illustrated in FIG. 2A, the computer 101 includes a central processing unit (CPU) 201, a read-only memory (ROM) 202, a random access memory (RAM) 204, and a storage 205. Furthermore, an input device 206, a display device 207, and an external interface 208 are also included. These components are connected to each other via a data bus 203.

The CPU 201 is a control unit configured to control the entire operation of the computer 101. The CPU 201 activates a system of the computer 101 by executing a start-up program stored in the ROM 202 and implements various functions, such as a document image display function and a function for inputting an instruction to the generative AI, by executing a control program stored in the storage 205.

The ROM 202 is a storage unit implemented using a non-volatile memory and stores the start-up program that activates the computer 101. The data bus 203 is a communication unit for data transmission and reception between the devices constituting the computer 101. The RAM 204 is a storage unit implemented using a volatile memory and is used as a work memory by the CPU 201 during execution of the control program.

The storage 205 is a storage unit implemented using a hard disk drive (HDD) and stores the control program, a document image, and an application (e.g., word processing, spreadsheet, presentation) file.

The input device 206 is an operation unit implemented using a mouse and/or a keyboard and receives operational input from a user operating the computer 101. The display device 207 is a display unit implemented using a liquid crystal display and displays a setting screen of the scanner 102 and an input screen of the generative AI server 103 to the user.

The external interface 208 is an interface connecting the computer 101 and the network 104 to receive a document image from the scanner 102 and transmit an instruction statement (prompt) to the generative AI server 103.

FIG. 2B is a diagram illustrating a hardware configuration of the scanner 102. The scanner 102 is not particularly limited, and any scanner with a scanning function, such as a multi-function printer/peripheral (MFP) can be used. As illustrated in FIG. 2B, the scanner 102 includes a CPU 231, a ROM 232, a RAM 234, a printer device 235, a scanner device 236, an original document conveyance device 237, and a storage 238. Furthermore, an input device 239, a display device 240, and an external interface 241 are also included. These components are connected to each other via a data bus 233.

The CPU 231 is a control unit configured to control the entire operation of the scanner 102. The CPU 231 activates a system of the scanner 102 by executing a start-up program stored in the ROM 232 and implements scanning, printing, and fax functions of the scanner 102 by executing a control program stored in the storage 238. The CPU 231 is an example of an instruction statement generation unit in the present disclosure.

The ROM 232 is a storage unit implemented using a non-volatile memory and stores the start-up program that activates the scanner 102. The data bus 233 is a communication unit for data transmission and reception between the devices constituting the scanner 102. The RAM 234 is a storage unit implemented using a volatile memory and is used as a work memory by the CPU 231 during execution of the control program.

The printer device 235 is an image output device and outputs a document image by printing it on a storage medium, such as paper.

The scanner device 236 is an image input device and optically scans the storage medium, such as paper, printed with text or a chart. The data obtained by the scanner device 236 through scanning is acquired as a document image. The scanner device 236 is an example of an original document image acquisition unit and a sample acquisition unit in the present disclosure.

The original document conveyance device 237 implemented using an auto document feeder (ADF) detects an original document placed on a document platen and conveys the detected original document individually to the scanner device 236. The storage 238 is a storage unit implemented using an HDD and stores the control program and the document image.

The input device 239 is an operation unit implemented using a touch panel and/or a hardware key and receives operational input from a user operating the scanner 102. The input device 239 is an example of an instruction reception unit in the present disclosure. The display device 240 is a display unit implemented using a liquid crystal display and displays and outputs a setting screen of the scanner 102 to the user.

The external interface 241 is an interface connecting the scanner 102 and the network 104 to transmit a document image to the computer 101 or transmit a document image and an instruction statement (prompt) to the generative AI server 103. The external interface 241 is an example of an instruction transmission unit in the present disclosure.

FIG. 2C is a diagram illustrating a hardware configuration of the generative AI server 103. The generative AI server 103 includes a CPU 261, a ROM 262, a RAM 264, a graphics processing unit (GPU) 265, a storage 266, an input device 267, a display device 268, and an external interface 269, and these components are connected to each other via a data bus 263.

The CPU 261 is a control unit configured to control the entire operation of the generative AI server 103. The CPU 261 activates a system of the generative AI server 103 by executing a start-up program stored in the ROM 262 and executes a control program stored in the storage 266. Note that the control program uses a large language model (LLM) to which multimodal data including at least an image and text can be input, and outputs a conversion result based on an instruction statement (prompt) provided in text form.

The ROM 262 is a storage unit implemented using a non-volatile memory and stores the start-up program that activates the generative AI server 103. The data bus 263 is a communication unit for data transmission and reception between the devices constituting the generative AI server 103.

The RAM 264 is a storage unit implemented using a volatile memory and is used as a work memory by the CPU 261 during execution of the control program. The GPU 265 is a computation unit configured to include an image processing processor. For example, the GPU 265 performs computation to convert input image and/or text data using the large language model based on a control command from the CPU 231.

The storage 266 is a storage unit implemented using an HDD and stores the control program, the large language model, the document image, the instruction statement (prompt), and an application file in a predetermined format.

The input device 267 is an operation unit implemented using a mouse and/or a keyboard and receives operational input to the generative AI server 103 from the user using the generative AI server 103. The display device 268 is a display unit implemented using a liquid crystal display and displays and outputs a setting screen of the generative AI server 103 to the user using the generative AI server 103.

The external interface 269 is an interface connecting the generative AI server 103 and the network 104. The external interface 269 receives a document image and an instruction statement (prompt) from the scanner 102 and transmits an output result of the large language model to the computer 101.

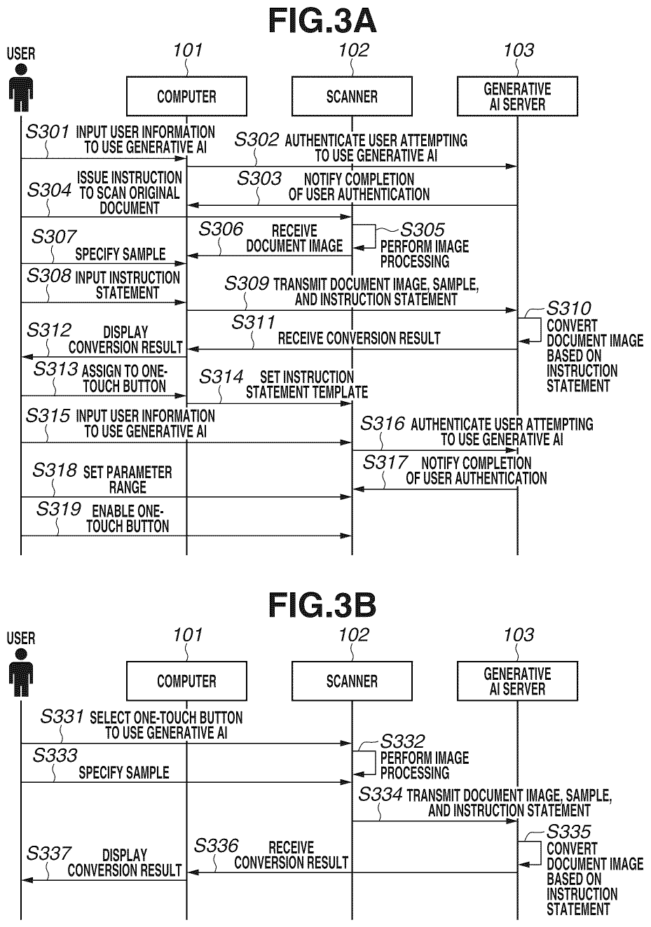

FIGS. 3A and 3B are diagrams illustrating sequences of the information processing system 100. The letter “S” in the description of each process refers to a step in the sequence, and the same applies to flowcharts described below. Further, for convenience of description, user operations are also described in terms of steps.

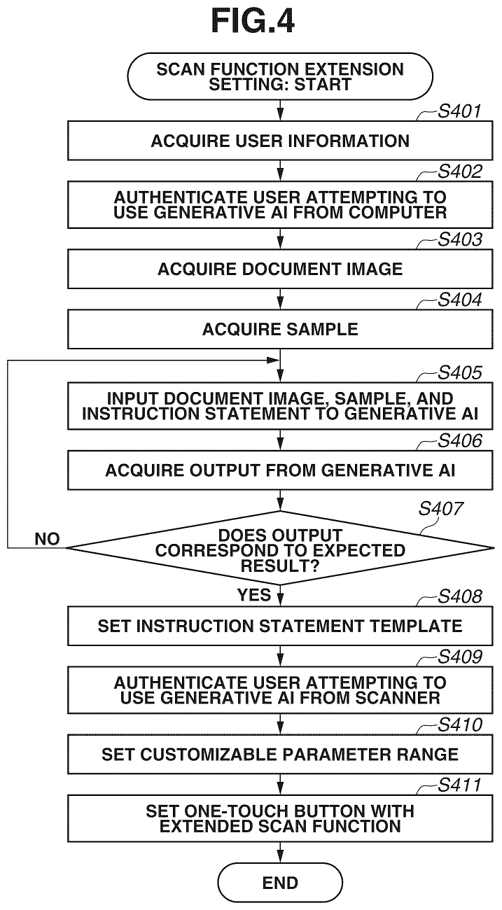

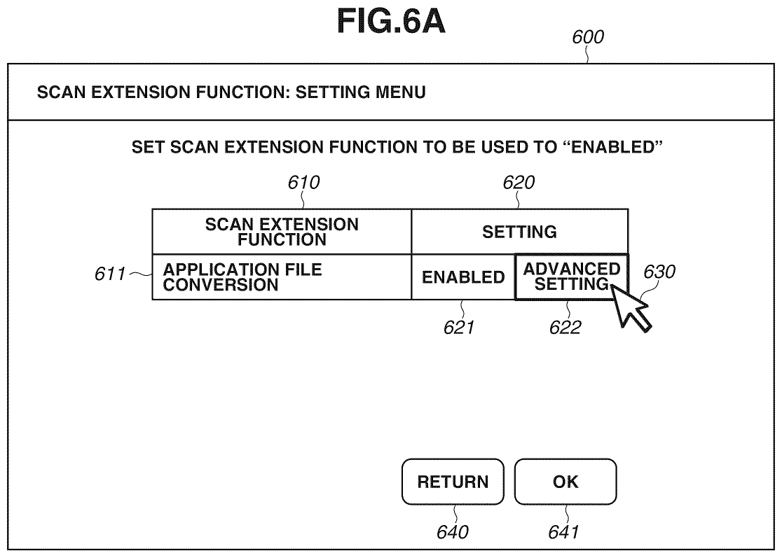

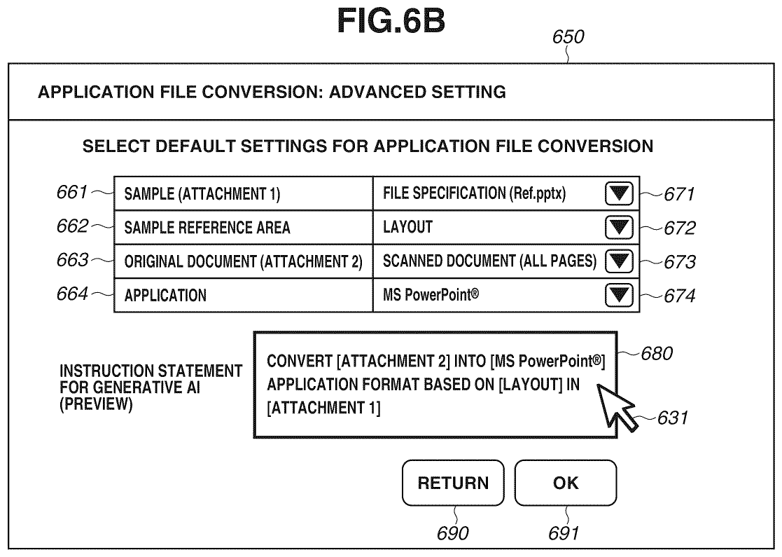

FIG. 3A illustrates a flow for generating a one-touch button to which the scan extension function is assigned. A method for configuring a setting to extend the scan function of the scanner 102 by the computer 101 in FIG. 3A will be described below with reference to FIG. 4. Further, operational inputs on the setting screens related to enabling the one-touch button in steps S313 to S319 will be described below with reference to FIGS. 6A and 6B.

In step S301, the user inputs user information to the computer 101 to use the service provided by the generative AI server 103 from the computer 101. The user information herein is used to control access to a log that records input and output data during use of the service provided by the generative AI server 103, and to control charging based on usage of the generative AI server 103 by the user.

In step S302, the computer 101 accesses the generative AI server 103, and user authentication is performed to enable use of the service provided by the generative AI server 103 from the computer 101.

In step S303, the generative AI server 103 notifies the computer 101 of the completion of user authentication performed in step S302.

In step S304, the user using the information processing system 100 issues an instruction to scan an original document, such as a paper document, by placing the original document on the original document conveyance device 237 of the scanner 102 and pressing a scan execution button using the input device 239.

In step S305, the scanner 102 performs image processing, such as optical character recognition (OCR) and handwriting detection, on a document image acquired by scanning the original document of the user using the scanner device 236.

In step S306, the document image data acquired using the scanner 102 is transmitted to the computer 101 and stored for use in subsequent steps by the user.

In step S307, the user specifies a sample (a document image or an application file in a predetermined format) to be referenced as a layout and design reference during conversion of the document image using the generative AI. The predetermined format may be any format, such as a Portable Document Format (PDF), a word processing application format, a spreadsheet application format, or a presentation application format. The same applies to the file format after conversion.

In step S308, the user inputs an instruction statement (prompt) to specify how the document image received in step S306 is to be converted using the generative AI server 103.

In step S309, the computer 101 transmits, to the generative AI server 103, the document image received in step S306, the sample specified in step S307, and the instruction statement (prompt) input in step S308 as a set.

In step S310, the generative AI server 103 converts the document image based on the instruction statement with reference to the sample.

In step S311, the generative AI server 103 transmits the conversion result of step S310 to the computer 101.

In step S312, the computer 101 displays the conversion result received from the generative AI server 103, and the user verifies whether a desired conversion result has been obtained based on the instruction input in step S308. In a case where a desired conversion result has not been obtained, the content of the instruction statement (prompt) input in step S308 is changed, and steps S308 to S312 are repeated.

In step S313, in a case where a desired conversion result has been obtained in step S312 based on the instruction statement (prompt) input in step S308, the user instructs the computer 101 to assign the instruction statement (prompt) to the one-touch button of the scanner 102.

In step S314, the computer 101 transmits the instruction statement (prompt) verified in step S308 to the scanner 102 based on the instruction from the user in step S313 and sets an instruction statement template to be used as the one-touch button. Specifically, the instruction statement (prompt) input in step S308 is set as an instruction statement template 680 in FIG. 6B.

In step S315, the user inputs user information to use the service provided by the generative AI server 103 from the scanner 102. By using the common user information for the user authentication in step S301 and the user authentication in step S315, the service provided by the generative AI server 103 can be used from both the computer 101 and the scanner 102.

Specifically, for example, the instruction statement and the document image transmitted from the scanner 102 can be input to the generative AI server 103, and the output result can be used from the computer 101. The user information herein is used to control access to the log that records input and output data during use of the service provided by the generative AI server 103, and to control charging based on usage of the generative AI server 103 by the user.

In step S316, the scanner 102 accesses the generative AI server 103, and user authentication is performed to enable use of the service provided by the generative AI server 103 from the scanner 102.

In step S317, the generative AI server 103 notifies the scanner 102 of the completion of user authentication performed in step S315.

In step S318, the user sets, from the scanner 102, a customizable parameter in the instruction statement used as the one-touch button for using the service provided by the generative AI server 103. Specifically, parameters 661 to 664 illustrated as examples in FIG. 6B in the instruction statement (prompt) input in step S308 are set.

In step S319, the user enables, from the scanner 102, the one-touch button for using the service provided by the generative AI server 103. Specifically, “enabled” is selected in an enabling setting 621 corresponding to a scan extension function 610 illustrated as an example in FIG. 6A.

Note that in steps S315 to S319, setting information enabled as the one-touch button after user authentication is stored as information associated with the user in the storage 238 of the scanner 102. Specifically, the user information for using the generative AI server 103 and the parameters 661 to 664 (sample, sample reference area, original document, application) used as default settings in a case where the scan extension function 610 is used via the one-touch button are stored.

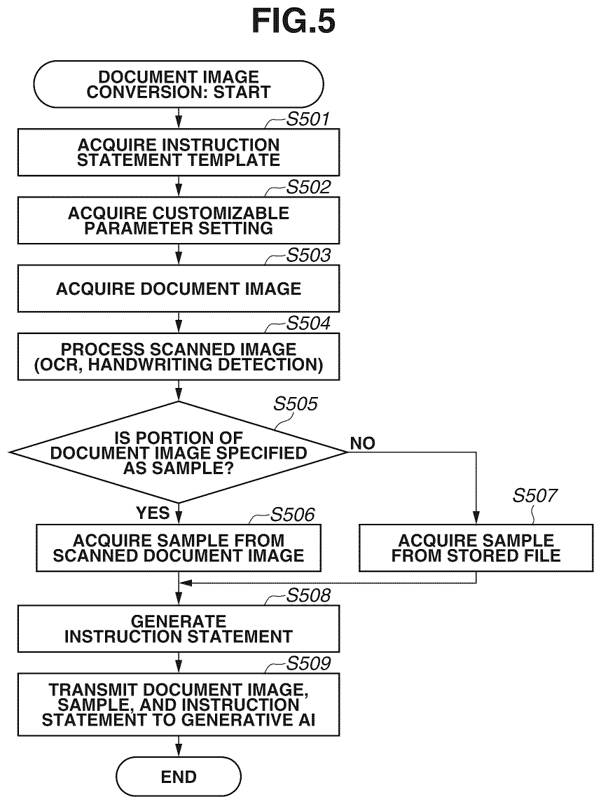

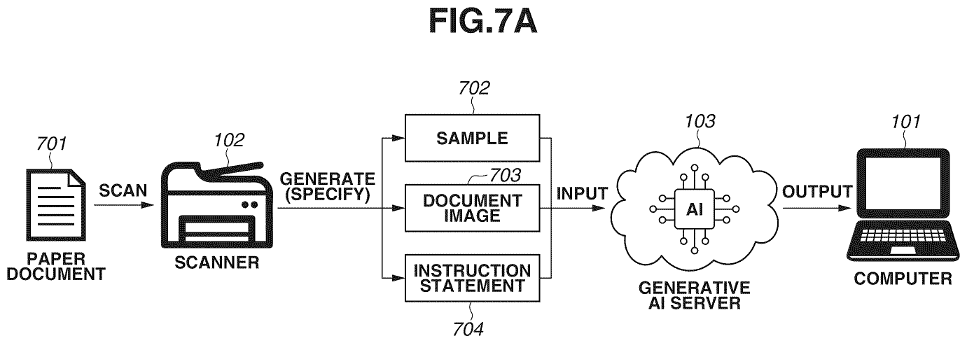

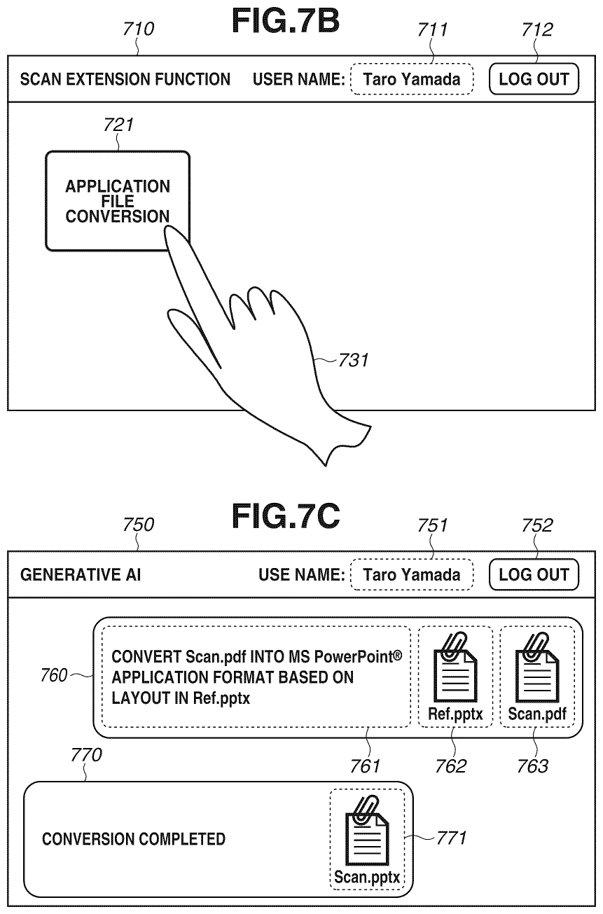

FIG. 3B illustrates a flow for selecting the one-touch button set in FIG. 3A and performing document image conversion during scanning. A method for document image conversion performed by the scanner 102 using the service provided by the generative AI server 103 in FIG. 3B will be described below with reference to FIG. 5. Further, operational inputs on input screens related to input to and output from the generative AI server 103 in steps S331, S336, and S337 will be described below with reference to FIGS. 7A to 7C.

In step S331, the user using the information processing system 100 selects the one-touch button set in step S313 to use the service provided by the generative AI server 103. The one-touch button selected by the user is configured to issue an instruction to scan the original document and an instruction to use the service provided by the generative AI server 103 simultaneously. To scan the original document, the original document, such as a paper document, is placed on the original document conveyance device 237 of the scanner 102, and the one-touch button is pressed using the input device 239 to issue an instruction to scan the original document, as in step S301. Details of step S331 will be described below with reference to FIG. 11.

In step S332, as in step S305, the scanner 102 performs image processing, such as OCR and handwriting detection, on a document image acquired by scanning the original document of the user using the scanner device 236.

In step S333, the user specifies a sample (a document image or an application file in a predetermined format) to be referenced as a layout and design reference during conversion of the document image using the generative AI. While the sample specified in step S333 corresponds to the sample specified in step S307, any data with a layout and design intended as a sample for the document image acquired in step S332 may be specified.

In step S334, the scanner 102 transmits, to the generative AI server 103, the document image acquired in step S332, the sample specified in step S333, and the instruction statement (prompt) associated with the one-touch button selected in step S331. Note that the data set transmitted from the scanner 102 to the generative AI server 103 in step S334 corresponds to the data set transmitted from the computer 101 to the generative AI server 103 in step S308.

In step S335, as in step S310, the generative AI server 103 converts the document image based on the instruction statement with reference to the sample.

In step S336, the generative AI server 103 transmits the conversion result of step S335 to the computer 101.

In step S337, the computer 101 displays the conversion result received from the generative AI server 103, and the user verifies whether a desired conversion result has been obtained based on the content selected using the one-touch button in step S331.

FIG. 4 is a flowchart illustrating a process for generating a one-touch button to which the scan extension function is assigned in FIG. 3A. The process illustrated in the flowchart in FIG. 4 is performed by the CPU 201 of the computer 101 by loading a program code stored in the ROM 202 or the storage 205 into the RAM 204 and executing the program code.

In step S401, the CPU 201 acquires, as the user input in step S301, user information for using the service provided by the generative AI server 103 from the computer 101.

In step S402, the CPU 201 authenticates the user attempting to use the generative AI server 103 from the computer 101, as described above in steps S302 and S303.

In step S403, the CPU 201 acquires the document image generated by scanning the original document, such as a paper document, using the scanner 102.

In step S404, the CPU 201 acquires the sample (a document image or an application file in a predetermined format) specified by the user. As described above in step S333, the acquired sample is referenced as a layout and design reference during conversion of the document image using the generative AI.

In step S405, the CPU 201 inputs an instruction statement (prompt) to specify how the document image received in step S401 is to be converted using the generative AI server 103. Specifically, an instruction is issued to perform a conversion into a file in the predetermined format specified in the instruction statement based on text obtained from an OCR result of a character string included in the document image based on the layout and design of the sample data.

In step S406, the CPU 201 acquires an output from the generative AI server 103 based on the instruction statement (prompt) input in step S402. Specifically, a result of a conversion into a file in the predetermined format specified in the instruction statement based on text obtained from an OCR result of a character string included in the document image based on the layout and design of the sample data is acquired.

In step S407, the CPU 201 determines whether the instruction statement (prompt) input in step S405 is appropriate. Specifically, in a case where the output based on the instruction statement does not correspond to the result expected by the user (NO in step S407), the content of the instruction statement (prompt) input in step S405 is changed, and steps S405 to S406 are repeated, whereas in a case where the output based on the instruction statement corresponds to the result expected by the user (YES in step S407), the processing proceeds to step S408.

In step S408, the CPU 201 sets a template for the instruction statement (prompt) based on a user instruction. Specifically, as illustrated by the instruction statement (preview) template 680 to the generative AI in FIG. 6B, a standard phrase that can be fixed within the instruction statement is set as a template. Specifically, for example, for an instruction statement intended to achieve an application file conversion 611 in FIG. 6A, the phrase “Convert [ ] into [ ] application format based on [ ] in [ ]” (where [ ] indicates a parameter) is set as a template.

In step S409, the CPU 201 authenticates the user attempting to use the generative AI server 103 from the scanner 102, as described above in steps S316 and S317. By using the common user information for the user authentication in step S403 and the user authentication in step S409, the service provided by the generative AI server 103 can be used from both the computer 101 and the scanner 102. Specifically, for example, the instruction statement and the document image transmitted from the scanner 102 can be input to the generative AI server 103, and the output result can be used from the computer 101.

In step S410, the CPU 201 sets one or more parameters 661 to 664 that can be controlled by changing a keyword in the instruction statement (prompt), based on a user instruction. Specifically, for example, the sample 661, the sample reference area 662, the original document 663, and the application 664 are set as parameters for use in the instruction statement intended to achieve “application file conversion” described above as an example in step S405.

Character strings used as keywords in part of the instruction statement (prompt), such as default values 671 to 674, are preset as default values for the parameters 661 to 664. Furthermore, character strings used as keywords in part of the instruction statement (prompt), such as the default values 671 to 674, are also preset as options (range) of values that can be selected as the parameters 661 to 664.

In step S411, the CPU 201 generates a one-touch button associated with the instruction statement template set in step S408 and the range of customizable parameters (including default values) set in step S410 and arranges the generated one-touch button in a selectable form in a scan extension function menu.

Specifically, for example, the application file conversion 611 of the scan extension function in FIG. 6A is “enabled” via the setting 621, and the information set in steps S408 and S410 is associated with the one-touch button via an advanced setting 622. Note that the settings of the one-touch button can be applied to the scanner 102 by accessing the scanner 102 from the computer 101 via the network 104 and inputting the information to a remote user interface (remote UI) screen.

FIG. 5 is a flowchart illustrating a process for converting a document image illustrated in FIG. 3B. The process illustrated in the flowchart in FIG. 5 is performed by the CPU 231 of the scanner 102 by loading a program code stored in the ROM 232 or the storage 238 into the RAM 234 and executing the program code.

In step S501, the CPU 231 acquires the instruction statement template associated with the one-touch button set in step S411. Specifically, for example, the instruction statement template 680 to the generative AI in FIG. 6B is acquired as an instruction statement associated with a one-touch button 721 of an application file conversion in FIG. 7B based on a user instruction input.

In step S502, the CPU 231 acquires a character string as a parameter to be used in the instruction statement template set in step S410. Specifically, for example, the default values 671 to 674 for the parameters used in the instruction statement associated with the one-touch button 721 of the application file conversion in FIG. 7B are acquired based on a user instruction input.

In step S503, the CPU 231 scans a paper document 701 in FIG. 7A using the scanner device 236 of the scanner 102 and acquires a document image as a sample 702 and a document image 703. The document image 703 is an example of an original document image in the present disclosure.

In step S504, the CPU 231 performs scanned image processing on the document images 702 and 703 acquired in step S503. Specifically, for example, OCR is performed on the document images 702 and 703 to acquire text included in the document images 702 and 703, or a handwriting pixel region included in the document images 702 and 703 is detected.

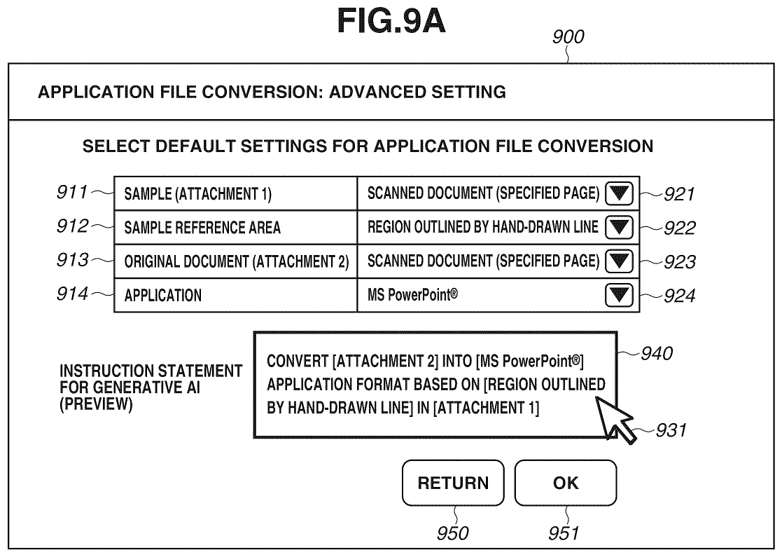

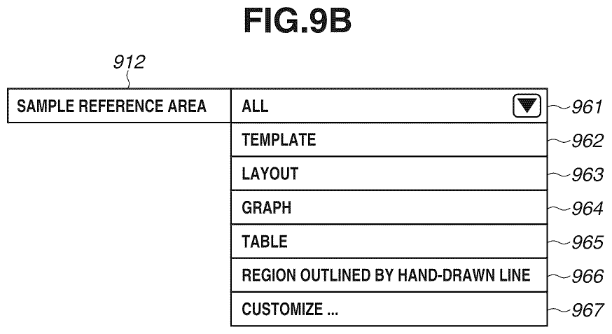

The scanned image processing performed in step S504 may be configured to selectively perform only the necessary image processing based on the settings acquired in steps S501 and S502. Specifically, for example, in a case where a setting for a region 966 outlined by a hand-drawn line is acquired as a sample reference area 912 in FIG. 9B, control may be applied to perform scanned image processing for detecting a handwriting pixel region.

In step S505, the CPU 231 determines whether to use a portion of the scanned document image (image data) or the application file in the predetermined format stored as electronic data, based on the setting for a method for specifying a sample 661 in FIG. 6B. Note that the specified sample is referenced as a layout and design reference during conversion of the document image using the generative AI. The document image and the application file are examples of a sample file in the present disclosure.

In step S505, in a case where the target to be specified as the sample 661 is a scanned document image (YES in step S505), the processing proceeds to step S506, whereas in a case where the target to be specified as the sample 661 is a file stored as electronic data (NO in step S505), the processing proceeds to step S507.

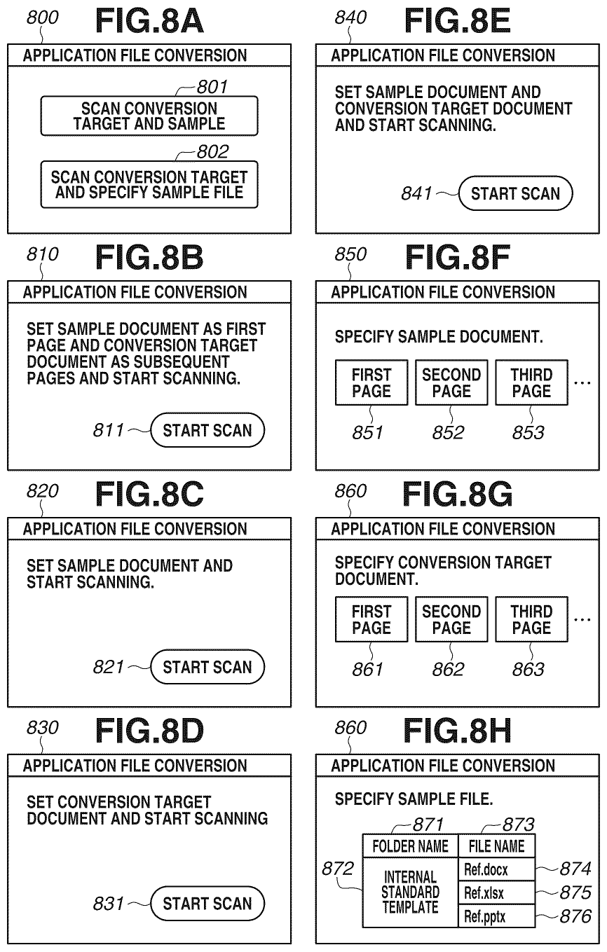

In step S506, the CPU 231 selects a document image to be referenced as a sample from a portion of the scanned document image. A specific example of a method for specifying a portion of a scanned document image will be described below with reference to examples of screens illustrated in FIGS. 8A to 8F.

In step S507, the CPU 231 selects a file (an application file in a predetermined format) to be referenced as a sample from the files stored in advance as electronic data in the storage 238. A specific example of a method for specifying a stored file will be described below with reference to examples of screens illustrated in FIGS. 8A and 8H.

In step S508, the CPU 231 acquires the instruction statement template acquired in step S501 and the character string acquired in step S502 as a parameter to be used in the instruction statement and generates an instruction statement 704 to issue an instruction to convert the document image acquired in step S503. Specifically, an instruction statement 761 is generated by assigning the customizable default values 671 to 674 in the instruction statement template 680 to the generative AI in FIG. 6B to the instruction statement associated with the one-touch button 721 of the application file conversion in FIG. 7B.

In step S509, the CPU 231 transmits the document image 703 acquired in step S503, the sample 702 acquired in step S505, and the instruction statement 704 generated in step S506 to the generative AI server 103 via the network 104 and the Internet 105. An output in response to the document image 703, the sample 702, and the instruction statement 704 transmitted to the generative AI server 103 may be received by the computer 101.

Specifically, as illustrated in FIG. 7C, an instruction input 760 including a set of an attached image 763 that is a data input of the document image 703, an attached image 762 that is a data input of the sample 702, and the instruction statement 761 that is the data input of the instruction statement 704 is executed to the generative AI server 103, and an output result 771 is received in response to the instruction input 760.

Note that steps S501 and S502 are an example of receiving an instruction, step S503 is an example of acquiring the original document image, steps S505 to S507 are an example of acquiring the sample file, step S508 is an example of generating an instruction statement, and step S509 is an example of transmitting the instruction transmission.

FIGS. 6A and 6B are diagrams illustrating examples of screens for setting the scan extension function.

FIG. 6A is a diagram illustrating an example of a screen for setting the scan extension function. As illustrated in FIG. 6A, a function intended to be implemented as a one-touch button is “enabled” by an operational input 630 on a scan extension function setting screen 600 so that the one-touch button of the scan extension function becomes available for use from the scanner 102. Specifically, for example, the enabling setting 621 for selecting “enabled” or “disabled” and the advanced setting 622 for a case where “enabled” is selected are set as the settings for the application file conversion 611 of the scan extension function 610.

The scan extension function setting screen 600 in FIG. 6A includes, for example, a return button 640 for returning without applying the changes on the setting screen and an OK button 641 for applying and finalizing the changes on the setting screen.

FIG. 6B is a diagram illustrating an example of a screen for inputting the advanced settings for the scan extension function.

A setting screen 650 for the advanced settings for the scan extension function in FIG. 6B is displayed in response to the operational input 630 to the advanced setting 622 for the application file conversion 611 in FIG. 6A.

Specifically, for example, as the advanced settings for a case where the one-touch button of the application file conversion 611 is used, the keywords in part of the text of the instruction statement template 680 to the generative AI may be defined as the parameters 661 to 664 in a modifiable form. By defining the default values and configuring the default values 671 to 674 for the parameters 661 to 664, standard settings for use in association with the one-touch button on the scanner 102 can be preset. The instruction statement template 680 for the generative AI can be modified by an instruction input 631.

The setting screen 650 for the advanced settings for the scan extension function in FIG. 6B includes, for example, a return button 690 for returning without applying the changes on the setting screen and an OK button 691 for applying and finalizing the changes on the setting screen.

FIGS. 7A to 7C are diagrams illustrating a data flow for document image conversion and example screens.

FIG. 7A is a diagram illustrating a data flow for document image conversion. As illustrated in FIG. 7A, the scanner 102 in the present disclosure scans the paper document 701 of the user and transmits the sample 702, the document image 703, and the instruction statement 704, which are generated or specified, to the generative AI server 103.

An output result from the generative AI server 103 may be received by the computer 101. As illustrated in steps S302, S303, S316, and S317 in FIG. 3A, since the user attempting to use the service provided by the generative AI server 103 from both the scanner 102 and the computer 101 is already authenticated, the data of the user can be referenced from either device.

FIG. 7B is a diagram illustrating an example of an operation screen 710 of the scanner 102 in FIG. 7A. As illustrated in FIG. 7B, the user selects the one-touch button of the scan extension function 610 on a touch panel screen with the functions of the input device 239 and the display device 240 of the scanner 102, and the instruction input 631 from the user is acquired. Specifically, for example, the one-touch button 721 associated with the application file conversion 611 set in advance as the scan extension function in FIG. 6A can be selected.

Note that the user using the generative AI server 103 from the scanner 102 uses the service provided by the generative AI server 103 as an already authenticated user in steps S302 and S303. User information 711 about the user using the generative AI server 103 may be managed in association with user information about the logged-in user of the scanner 102. Upon detecting the press of a logout button 712, the scanner 102 terminates reception of an instruction input 731 from the logged-in user.

FIG. 7C is a diagram illustrating an example of a screen for a case where the service provided by the generative AI server 103 is used from the display device 207 of the computer 101 in FIG. 7A. As illustrated in FIG. 7C, an output result 770 from the generative AI is obtained as a response to the instruction input 760 from the user on a screen 750 of the service provided by the generative AI server 103.

The sample 702 in FIG. 7A is automatically input as the attached image 762 in the instruction input 760 from the user. Further, the document image 703 in FIG. 7A is automatically input as the attached image 763 in the instruction input 760 from the user. Further, the instruction statement 704 in FIG. 7A is automatically input as the instruction statement 761 in the instruction input 760 from the user.

The user using the generative AI server 103 from the computer 101 uses the service provided by the generative AI server 103 as an already authenticated user in steps S316 and S317. User information 751 about the user using the generative AI server 103 may be managed in association with user information about the logged-in user of the computer 101. Upon detecting the press of a logout button 752, the computer 101 terminates reception of an instruction input 760 from the logged-in user corresponding to the user information 751.

While FIG. 7B illustrates an example of an operation screen that uses the one-touch button of the scan extension function, any configuration capable of receiving operational input consistent with the spirit of the present disclosure using a different screen example may be employed. Specifically, for example, an operational input from the user may be received by performing transmission to the generative AI server 103, which has authenticated the user, as a destination via an operation screen having an extended version of a conventional SEND function for transmitting a scanned image via email.

### First Modified Example

FIGS. 8A to 8H are diagrams illustrating a case where a scan flow allowing detailed specification of a conversion target and a sample is added following selection of the one-touch button 721 associated with the application file conversion 611 in FIG. 7B.

FIG. 8A illustrates an example of a screen 800 displayed following selection of the one-touch button 721 associated with the application file conversion 611 in FIG. 7B. In FIG. 8A, a “scan conversion target and sample” 801 and a “scan conversion target and specify sample file” 802 are selectable. In a case where the “scan conversion target and sample” 801 is selected, a document image can be specified as a sample and another document image as a conversion target among the document images acquired by scanning the original documents using the scanner 102.

FIG. 8B illustrates an example of a screen 810 for implementing a scan flow in which an original document to be used as a sample and another original document to be used as a conversion target are scanned collectively in a case where the “scan conversion target and sample” 801 in FIG. 8A is selected. For example, by predetermining to set an original document of a sample as a first page and an original document of a conversion target as second and subsequent pages, the document images 702 and 703 corresponding to the original document to be used as a sample and the original document to be used as a conversion target can be acquired with a single instruction via a start scan 811.

FIGS. 8C and 8D illustrate examples of screens 820 and 821 for a case where two scans are performed, one for the sample and one for the conversion target, instead of processing corresponding to a single scan in FIG. 8B. As illustrated in FIG. 8C, only the original document to be used as a sample is set, and the sample 702 corresponding to the original document to be used as a sample is acquired based on an instruction input via a start scan 821. Similarly, as illustrated in FIG. 8D, only the original document to be used as a conversion target is set, and the document image 703 corresponding to the original document to be used as a conversion target is acquired based on an instruction input via a start scan 831.

FIGS. 8E to 8G illustrate examples of screens 840, 850, and 860 for implementing the processing corresponding to the single scan in FIG. 8B using another specifying method. First, as illustrated in FIG. 8E, the original document to be used as a sample and the original document to be used as a conversion target are set collectively, and document images corresponding to the original documents to be used as a sample or conversion target are acquired collectively based on an instruction input via a start scan 841.

Next, as illustrated in FIG. 8F, the sample 702 corresponding to the original document to be used as a sample is specified from pages 851 to 853 of the acquired document images based on an instruction input. Similarly, as illustrated in FIG. 8G, the document image 703 corresponding to the original document to be used as a conversion target is specified from pages 861 to 863 of the acquired document images based on an instruction input.

FIG. 8H is a diagram illustrating an example of a screen 860 for specifying a sample file in a case where a scan workflow corresponding to the “scan conversion target and specify sample file” 802 in FIG. 8A is selected. As illustrated in FIG. 8H, a sample file can be specified from the files stored in advance in the storage 238 of the scanner 102.

Specifically, for example, a file 874 with a file name 873 of “Ref.docx” stored in a folder with a folder name 871 of an internal standard template 872 can be specified. Similarly, a file 875 named “Ref.xlsx” and a file 876 named “Ref.pptx” are prepared as standard templates for internal use and may be specified as samples. Note that the document image 703 corresponding to the original document to be used as a conversion target may also be acquired in the scan workflow corresponding to the “scan conversion target and specify sample file” 802, as in FIG. 8D.

### Second Modified Example

FIGS. 9A and 9B are diagrams illustrating examples of targets or ranges that may be specified as a sample reference area in the advanced settings for application file conversion illustrated in FIG. 6B.

FIG. 9A is a diagram illustrating an example of a screen for inputting the advanced settings for the scan extension function.

A setting screen 900 for the advanced settings for the scan extension function in FIG. 9A is displayed in response to the operational input 630 to the advanced setting 622 for the application file conversion 611 in FIG. 6A.

Specifically, for example, as the advanced settings for a case where the one-touch button of the application file conversion 611 is used, the keywords in part of the text of the instruction statement template 940 to the generative AI may be defined as the parameters 911 to 914 in a modifiable form.

By defining the default values and configuring the default values 921 to 924 for the parameters 911 to 914, standard settings for use in association with the one-touch button on the scanner 102 can be preset. The instruction statement template 940 for the generative AI can be modified by an instruction input 931.

The setting screen 900 for the advanced settings for the scan extension function in FIG. 9A includes, for example, a return button 950 for returning without applying the changes on the setting screen and an OK button 951 for applying and finalizing the changes on the setting screen.

FIG. 9B is a diagram illustrating examples of targets or ranges that may be specified for the sample reference area 912 in FIG. 9A. As illustrated in FIG. 9B, the following options may be configured to be selectable as a sample reference area: all 961, template 962, layout 963, graph 964, and table 965. The all 961 is selected to reference the entire sample, whereas the template 962, the layout 963, the graph 964, or the table 965 is selected to reference a portion of the sample.

Further, as illustrated in FIG. 9B, the region 966 outlined by a hand-drawn line, which is a portion included in the sample, may be configured to be selectable as a sample reference area corresponding to a range of a portion of the sample. The region 966 outlined by a hand-drawn line may be specified by performing scanned image processing to detect a handwriting pixel region, which is described above in step S504. The foregoing examples are not limitations, and text describing the document image components of the sample in natural language recognizable by the generative AI may be configured to be settable via a customize 967, similarly to the options 962 to 966.

As described above, according to the present disclosure, by inputting a sample image specified by the user to the generative AI in addition to text based on an instruction from the user, a result of converting a document image into data with a layout and design intended by the user is output.

The first exemplary embodiment describes a method in which a sample, a document image, and an instruction statement are generated based on a paper document of the user by inputting an instruction from the scanner 102 and then transmitted to the generative AI server 103. A second exemplary embodiment will describe a method in which a sample file is input during the interaction while the computer 101 is accessing the generative AI server 103 after a document image and an instruction statement are generated by inputting an instruction from the scanner 102.

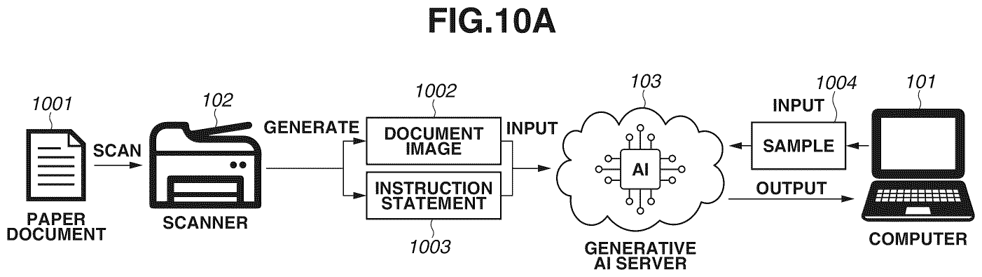

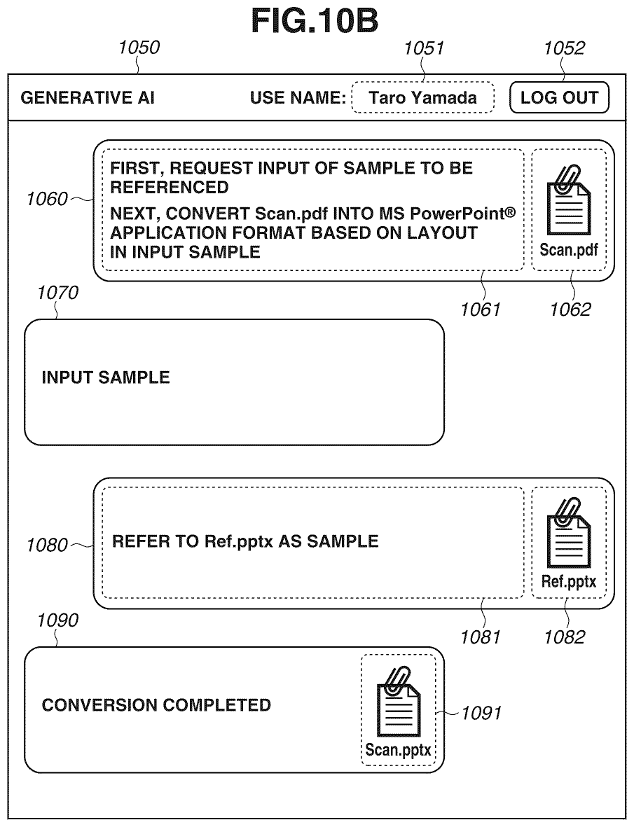

FIGS. 10A and 10B are diagrams illustrating a data flow for document image conversion and example screens.

FIG. 10A is a diagram illustrating a data flow for document image conversion. As illustrated in FIG. 10A, the scanner 102 according to the second exemplary embodiment of the present disclosure scans a paper document 1001 of the user and transmits a generated document image 1002 and a generated instruction statement 1003 to the generative AI server 103. Thereafter, a sample 1004 from the computer 101 is input during the interaction while the computer 101 is accessing the generative AI server 103, and an output result from the generative AI server 103 is received. As illustrated in steps S302, S303, S316, and S317 in FIG. 3A, since the user attempting to use the service provided by the generative AI server 103 from both the scanner 102 and the computer 101 is already authenticated, the data of the user can be referenced from either device. FIG. 10B is a diagram illustrating an example of a screen for a case where the service provided by the generative AI server 103 is used from the display device 207 of the computer 101 in FIG. 10A. As illustrated in FIG. 10B, output results 1070 and 1090 are obtained as responses from the generative AI to instruction inputs 1060 and 1080 from the user on a screen 1050 of the service provided by the generative AI server 103.

The document image 1002 in FIG. 10A is automatically input as an attached image 1062 in the instruction input 1060 from the user. Further, the instruction statement 1003 in FIG. 10A is automatically input as an instruction statement 1061 in the instruction input 1060 from the user. The instruction statement 1061 according to the second exemplary embodiment of the present disclosure preliminary including an instruction statement “requesting the user to input a sample to be referenced” is automatically input.

Accordingly, the response 1070 from the generative AI to the instruction input 1060 from the user requests input of a sample to be referenced. Thus, during subsequent interaction with the generative AI, the user is prompted to manually input a sample 1082 as an attached file from the computer 101 as the instruction input 1080 from the user.

While the manual input from the user may include an instruction statement 1081 illustrated as an example in FIG. 10B, regardless of the presence or absence of the instruction statement 1081, the generative AI server 103 can interpret the attached file as the sample 1082. During subsequent interaction, the generative AI server 103 outputs, as the response 1090 from the generative AI, a result 1091 of converting the attached image 1062 based on the instruction statement 1061 with reference to the sample 1082.

Note that the user using the generative AI server 103 from the computer 101 uses the service provided by the generative AI server 103 as an already authenticated user in steps S316 and S317. User information 1051 about the user using the generative AI server 103 may be managed in association with user information about the logged-in user of the computer 101. Upon detecting the press of a logout button 1052, the computer 101 terminates reception of the instruction inputs 1060 and 1080 from the logged-in user corresponding to the user information 1051.

As described above, according to the second exemplary embodiment of the present disclosure, a sample input during interaction between the computer 101 and the generative AI server 103 is referenced, and a result of conversion into data with a layout and design intended by the user is output.

### OTHER EMBODIMENTS

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2024-106838, filed Jul. 2, 2024, which is hereby incorporated by reference herein in its entirety.

What is claimed is:

1. An information processing method comprising:
receiving an instruction that causes a generative artificial intelligence (AI) to generate document data, the document data being generated by rearranging the information included in an original document image according to layout of a sample file, and the instruction being generated based on a user operation;
acquiring the original document image;
acquiring the sample file;
generating an instruction statement corresponding to the received instruction; and
transmitting the original document image, the sample file, and the instruction statement to a server of the generative AI.

2. The information processing method according to claim 1, wherein the original document image is acquired by scanning a physical document.

3. The information processing method according to claim 1, wherein the instruction includes an instruction to acquire a specified portion of the sample file as a sample.

4. The information processing method according to claim 3,
wherein the portion can be specified during receiving of the instruction, and
wherein any one of a template, a layout, a graph, a table, or a region outlined by a hand-drawn line is included as an option for the portion.

5. The information processing method according to claim 1, wherein the sample file is image data acquired by scanning.

6. The information processing method according to claim 1, wherein the sample file is electronic data specified by a user.

7. A non-transitory computer-readable storage medium storing executable instructions, which when executed by one or more processors of an information processing apparatus, cause the information processing apparatus to perform a control method, the control method comprising:
receiving an instruction that causes a generative AI to generate document data, the document data being generated by rearranging the information included in an original document image according to layout of a sample file, and the instruction being generated based on a user operation;
acquiring the original document image;
acquiring the sample file;
generating an instruction statement corresponding to the instruction; and
transmitting the original document image, the sample file, and the instruction statement to a server of the generative AI.

8. An information processing apparatus comprising:
an instruction reception unit configured to receive an instruction that causes a generative AI to generate document data, the document data being generated by rearranging the information included in an original document image according to layout of a sample file, and the instruction being generated based on a user operation;
an original document image acquisition unit configured to acquire the original document image;
a sample acquisition unit configured to acquire the sample file;
an instruction statement generation unit configured to generate an instruction statement corresponding to the instruction; and
an instruction transmission unit configured to transmit the original document image, the sample file, and the instruction statement to a server of the generative AI.

9. The information processing apparatus according to claim 8, wherein the original document image acquisition unit acquires the original document image by scanning an original document.

10. The information processing apparatus according to claim 8, wherein the instruction includes an instruction to acquire a specified portion of the sample file as a sample.

11. The information processing apparatus according to claim 10,
wherein the portion can be specified via the instruction reception unit, and
wherein any one of a template, a layout, a graph, a table, or a region outlined by a hand-drawn line is included as an option for the portion.

12. The information processing apparatus according to claim 8, wherein the sample file is image data acquired by scanning.

13. The information processing apparatus according to claim 8, wherein the sample file is electronic data specified by a user.

14. A multi-function printer comprising:
an instruction reception unit configured to receive an instruction that causes a generative AI to generate document data, the document data being generated by rearranging the information included in an original document image according to layout of a sample file, and the instruction being generated based on a user operation;
an original document image acquisition unit configured to acquire the original document image;
a sample acquisition unit configured to acquire the sample file by using a scanner;
an instruction statement generation unit configured to generate an instruction statement corresponding to the instruction; and
an instruction transmission unit configured to transmit the original document image, the sample file, and the instruction statement to a server of the generative AI.
